(19) United States
(12) Patent Application Publication
(10) Pub. No.: US 2023/0045309 A1
(43) Pub. Date: Feb. 9, 2023

(54) Meat Trussing Apparatus

(71) Applicant: Kobrand Products, LLC, Boone, NC (US)

(72) Inventors: Scott Kobryn, Boone, NC (US); Ryan Vick, Zionville, NC (US)

(73) Assignee: Kobrand Products, LLC, Boone, NC (US)

(21) Appl. No.: 17/817,645

(22) Filed: Aug. 4, 2022

Related U.S. Application Data
(60) Provisional application No. 63/229,095, filed on Aug. 4, 2021.

(51) Int. Cl. A47J 43/18; A23B 4/03

(52) U.S. Cl. CPC A47J 43/18; A23B 4/031; A23V 2002/00

(57) ABSTRACT

A trussing apparatus comprises a main portion coupled to opposing end portions. The main portion includes at least one receiving member and at least one support member. A curvature of the at least one receiving member permits various sizes, shapes, and cuts of meat to be disposed in the trussing apparatus. The at least one receiving member has at least one hook-like formation configured to cooperate with one or more restraining elements to secure at least one piece of meat in the trussing apparatus.

### CROSS-REFERENCE TO RELATED APPLICATION

This application claims the benefit of U.S. Provisional Patent Application Ser. No. 63/229,095, filed Aug. 4, 2021, the entirety of which is herein incorporated by reference.

### FIELD

The disclosure relates to a meat trussing apparatus, and more particularly to a meat trussing apparatus, which is simple in design, easily cleaned, and performs efficiently and effectively.

### BACKGROUND

Trussing and hanging meat for dry-aging helps the meat age. Trussing meat before roasting helps retain its shape while it cooks in the oven and stops the meat from spreading. This method can also be used for stuffed and rolled joints of meat to hold them together. Tying and trussing the meat, especially large cuts of meat, for hanging and dry-aging is an important part of handling the meat for best results.

A conventional meat trussing system incorporates the use of an elastomeric net to receive and restrain meats and other food components. At least one flexible wrapper encases the food products forming a cylindrical mass having a low coefficient of friction with respect to the elastomeric net. The wrapper is preferably provided with at least one perforation adapted to be circumferentially disposed near the midpoint of the food products within the elastomeric net. The wrapping sheets are formed in a continuous roll containing a longitudinal perforation. The roll may be disposed within a dispensing device having a cutting tool to allow for the detachment of any number of sheets of a predetermined length. However, such prior art meat trussing systems contaminate surfaces and hand with blood and other contaminates from the meat.

Therefore, it would be desirable to provide a meat trussing apparatus, which is simple in design, easily cleaned, and performs efficiently and effectively.

### SUMMARY

In concordance and agreement with the presently described subject matter, a meat trussing apparatus, which is simple in design, easily cleaned, and performs efficiently and effectively, has surprisingly been discovered.

The presently disclosed meat trussing apparatus is particularly suited for large cuts of meat such as those professionally aged and will not contaminate surfaces or hands with blood or other contaminants. Such meat trussing apparatus may also adjust to any shape or size of meat cut.

In one embodiment, a trussing apparatus, comprises: a main portion including at least one receiving member, wherein the at least one receiving member has at least one hook-like formation configured to cooperate with at least one restraining element capable of securing at least one piece of meat.

In some embodiments, the at least one restraining element is flexible.

In some embodiments, the at least one receiving member has a generally arcuate shape.

In some embodiments, a curvature of the at least one receiving member is opposite of a curvature of the at least one hook-like formation.

In some embodiments, the at least one receiving member includes one hook-like formation at a first end thereof and another hook-like formation at an opposing second end thereof.

In some embodiments, the main portion includes a plurality of receiving members that are laterally spaced apart and arranged in a linear array.

In some embodiments, a radius of curvature of a center section of the at least one receiving member varies from a radius of curvature of at least one end section of the at least one receiving member.

In some embodiments, a radius of curvature of a center section of the at least one receiving member is less than a radius of curvature of at least one end section of the at least one receiving member.

In some embodiments, at least one receiving member is configured to receive various sizes, shapes, and cuts of meat therein.

In some embodiments, the trussing apparatus further comprises at least one end portion coupled the main portion.

In some embodiments, the at least one end portion is configured to raise the main portion off of a supporting surface.

In some embodiments, at least one of the main portion and the at least one end portion is formed from a stainless steel material.

In some embodiments, the trussing apparatus further comprises a handle coupled to at least one of the main portion and the at least one end portion.

In some embodiments, the at least one end portion includes a frame and at least one cross-member coupled to the frame.

In some embodiments, the frame includes a first pair of opposing side members and a second pair of opposing side members.

In some embodiments, the first pair of opposing side members are laterally offset from the second pair of opposing side members.

In another embodiment, a trussing apparatus, comprises: a main portion configured to cooperate with at least one restraining element capable of securing at least one piece of meat; and at least one end portion coupled to the main portion, wherein the at least one end portion is configured to facilitate a positioning of the trussing apparatus.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a meat trussing apparatus according to an embodiment of the present disclosure;

FIG. 2 is a front view of the meat trussing apparatus of FIG. 1;

FIG. 3 is a left side elevational view of the meat trussing apparatus of FIGS. 1 and 2;

FIG. 4 is a top plan view of the meat trussing apparatus of FIGS. 1-3; and

FIG. 5 is a front perspective view of the meat trussing apparatus of FIGS. 1-4, wherein a meat cut is disposed therein.

### DETAILED DESCRIPTION

The following description of technology is merely exemplary in nature of the subject matter, manufacture and use of one or more presently disclosed subject matters, and is not intended to limit the scope, application, or uses of any specific presently disclosed subject matter claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

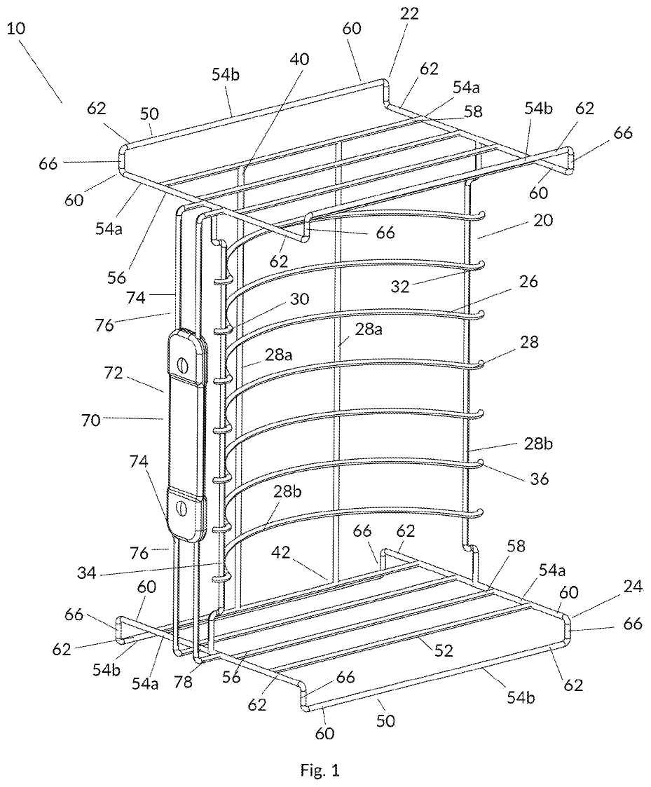

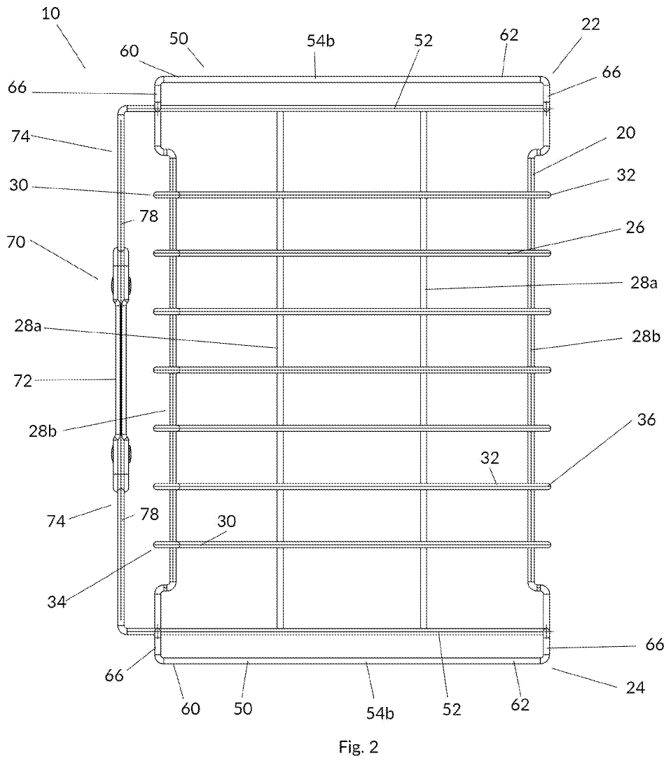

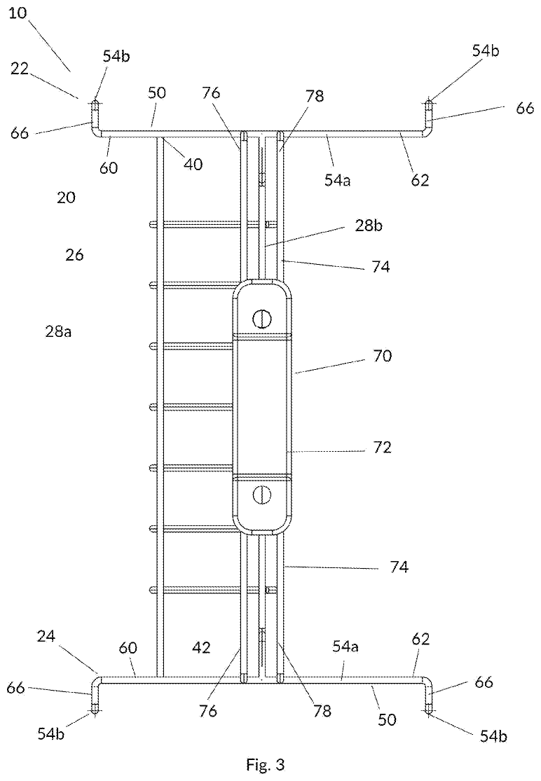

FIGS. 1-4 illustrate a meat trussing apparatus 10 in accordance with an embodiment of the present disclosure. The meat trussing apparatus 10 shown may for handling, trussing, hanging, dry-aging, and/or storing at least one cut of meat 100. Preferably, the meat trussing apparatus 10 may be particularly well-suited for large cuts of meat 100 such as those professionally aged. It is understood, however, that the meat trussing apparatus 10 may be configured to adjust to any shape or size of meat cut 100. The meat trussing apparatus 10 of the present disclosure may also militate against a contamination of surfaces or hands with blood or other contaminants from the meat 100. A size, shape, and configuration of the meat trussing apparatus 10 allows for stacking, nesting with other meat trussing apparatuses 10, and thereby increased storage density in residential and commercial use. It should be appreciated that the meat trussing apparatus 10 may be suitable for other applications as desired.

In some embodiments, the meat trussing apparatus 10 may comprise a main portion 20 having opposing end portions 22, 24 coupled thereto. Although the end portions 22, 24 shown are integrally formed with the main portion 20, it is understood that the end portions 22, 24 may be separate and distinct components from the main portion 20.

The main portion 20 may include one or more arcuate-shaped receiving members 26 and one or more elongate support members 28. A radius of curvature of the receiving members 26 permits the meat trussing apparatus 10 to accommodate various sizes, shapes, and cuts of meat 100. In certain embodiments, a radius of curvature R1 of a center section of the receiving members 26 may be less than a radius of curvature R2 of each of end sections thereof. As illustrated, the receiving members 26 may be laterally spaced apart and configured in a linear array on the support members 28. Such configuration also permits the meat trussing apparatus 10 to accommodate the various sizes, shapes, and cuts of meat 100 as well as aid a user in cutting the meat 100 after aging or hanging. In one preferred embodiment, the main portion 20 includes seven receiving members 26 and four support members 28, comprising two inner support members 28a and two outer support members 28b. As best seen in FIG. 1, the support members 28 may be spaced apart along the curvature of the receiving members 26. In certain embodiments, the support members 28 may be coupled to the receiving members 26 at regular intervals along the curvature thereof.

Opposing ends 30, 32 of each of the receiving members 26 may be bent rearwards to form respective hook-like formations 34, 36. In some embodiments, each of the hook-like formations 34, 36 may be partially bent around and extending outwardly past a corresponding one of the support members 28. As shown, a curvature of the hook-like formations 34, 36 is opposite to the curvature of the curvature of the receiving members 26. Distal ends 40, 42 of the support members 28 may be coupled to the end portions 22, 24, respectively.

Each of the end portions 22, 24 may comprise a frame 50 and one or more cross-members 52. In some embodiments, the frame 50 may be a generally rectangular shape comprising a first pair of opposing side members 54a and a second pair of opposing side members 54b. It is understood, however, that the frame 50 may have any suitable shape as desired. In one preferred embodiment, the end portions 22, 24 each include four cross-members 52. More or less of the cross-members 52 than shown may be employed. As depicted in FIG. 1, the ends 40, 42 of the inner support members 28a may be coupled to one of the cross-members 52 and the ends 40, 42 of each of the outer support members 28b may be coupled to a corresponding one of the opposing side members 54a.

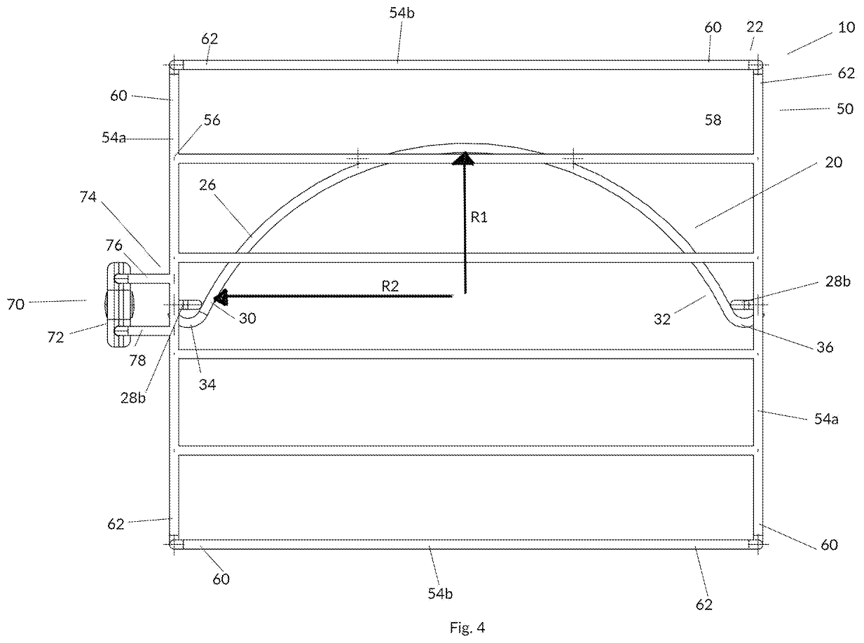

As more clearly depicted in FIG. 4, the cross-members 52 may be laterally spaced apart and configured in a linear array. In certain embodiments, the cross-members 52 may be coupled to the frame 50 at regular intervals, if desired. Distal ends 56, 58 of the cross-members 52 may be coupled to the opposing side members 54a of the frame 50. It is understood, however, that the ends 56, 58 of the cross-members 52 may be alternatively coupled to the opposing side members 54b of the frame 50.

As illustrated in FIG. 1, each of the side members 54a, 54b may include a first end 60 and a second end 62. The first end 60 of one of the side members 54a may be directly or indirectly coupled to the second end 62 of an adjacent one of the side members 54b. Likewise, the second end 62 of one of the side members 54a may be directly or indirectly coupled to the first end 60 of an adjacent one of the side members 54b. A connector 66 may be employed to couple the ends 60, 62 of the side members 54a, 54b when the side members 54a are laterally offset from the side members 54b as shown in FIG. 1. Such offset of the side members 54a from the side members 54b raises the main portion 20 of the meat trussing apparatus 10 off of a support base (not depicted) or other surfaces when handling, hanging, dry-aging, or storing the meat 100, and thereby, enhances a flow of a fluid (e.g. air) around the cut of meat 100 disposed in the meat trussing apparatus 10.

As depicted in FIGS. 1-4, the meat trussing apparatus 10 may further include a handle 70. The handle 70 may facilitate a positioning and transport of the meat trussing apparatus 10 as well as improve ease of use. In some embodiments, the handle 70 comprises a grip portion 72 connected to the main portion 20 and/or the end portions 22, 24 by one or more coupling members 74. More particularly, leg portions 76, 78 of each of the coupling members 74 may be coupled to one of the opposing side members 54a.

It should be appreciated that any or all of the parts of the meat trussing apparatus 10 may be produced from a heat-resistant and/or heat-tolerant material such as a stainless steel material, for example. It is also understood that any or all of the parts of the meat trussing apparatus 10 may include a coating disposed thereon to militate against corrosion and enhance a cleaning thereof.

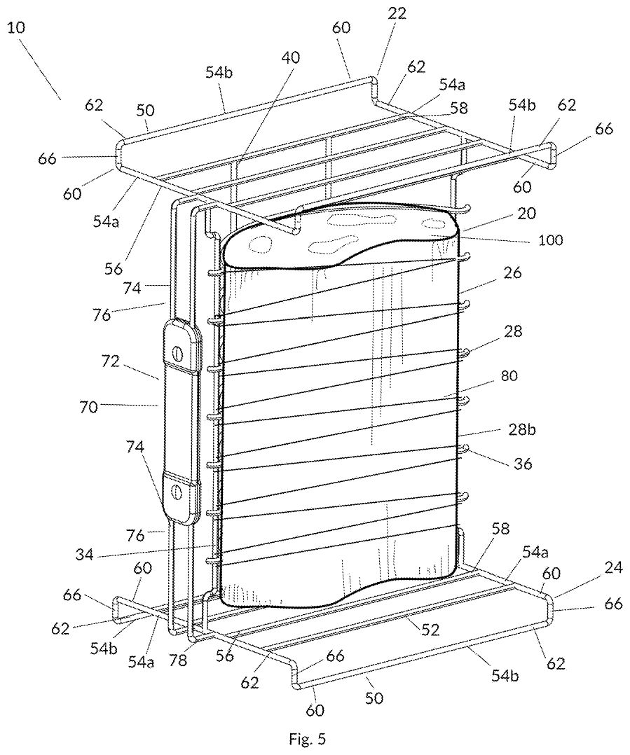

The meat trussing apparatus 10 may be provided with one or more restraining elements 80 shown in FIG. 5. In certain embodiments, the restraining elements 80 may be flexible. For example, the one or more restraining elements 80 may be string, cord, wire, and the like. The one or more restraining elements 80 may be a single, continuous long length of material or a plurality of short lengths of material, if desired. In some embodiments, each of the hook-like formations 34, 36 of the receiving members 26 is configured to receive the one or more restraining elements 80 therein. In other embodiments, the one or more restraining elements 80 may be looped around the hook-like formations 34, 36 of the receiving members 26. The hook-like formations 34, 36 permit the one or more restraining elements 80 to be tightened and/or drawn taut against the meat cut 100. Accordingly, the meat trussing apparatus 10 may be capable of retaining any size or shape of meat cut 100 for hanging, storing, transporting, or cooking.

Accordingly, the presently disclosed meat trussing apparatus 10 is simple in design, easily cleaned, and performs efficiently and effectively.

In operation, the meat trussing apparatus 10 is laid on the supporting surface with the curvature of the receiving members 26 towards the supporting surface. A cut of meat 100 is then placed onto the receiving members 26. Preferably, the meat cut 100 is disposed in the meat trussing apparatus 10 in the same position as it would be in during hanging. Once the meat cut 100 is in the desired position, the one or more restraining elements 80 are then looped around and/or laced through the hook-like formations 34, 36 of one or more of the receiving members 26. The one or more restraining elements 80 are adjusted depending on a size and shape of the meat cut 100. Typically, the one or more restraining elements 80 are tightened and pulled taut again the meat cut 100. The one or more restraining elements 80 are then tied and secured to militate against inadvertent loosening and/or undesired separation. The meat trussing apparatus 10 with the meat cut 100 secured therein is then positioned for desired results such as in a dry-aging machine, hanging, or in a horizontal manner with optimal fluid flow (e.g. airflow) around the meat cut 100 for safety and efficient and effective performance.

As to a further discussion of the manner of usage and operation of the presently disclosed subject matter, the same should be apparent from the above description. Accordingly, no further discussion relating to the manner of usage and operation will be provided. With respect to the above description, it is to be realized that the optimum dimensional relationships for the parts of the presently disclosed subject matter, to include variations in size, materials, shape, form, function and manner of operation, assembly and use, are deemed readily apparent and obvious to one skilled in the art, and all equivalent relationships to those illustrated in the drawings and described in the specification are intended to be encompassed by the presently disclosed subject matter. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A trussing apparatus, comprising:
a main portion including at least one receiving member, wherein the at least one receiving member has at least one hook-like formation configured to cooperate with at least one restraining element capable of securing at least one piece of meat.

2. The trussing apparatus of claim 1, wherein the at least one restraining element is flexible.

3. The trussing apparatus of claim 1, wherein the at least one receiving member has a generally arcuate shape.

4. The trussing apparatus of claim 1, wherein a curvature of the at least one receiving member is opposite of a curvature of the at least one hook-like formation.

5. The trussing apparatus of claim 1, wherein the at least one receiving member includes one hook-like formation at a first end thereof and another hook-like formation at an opposing second end thereof.

6. The trussing apparatus of claim 1, wherein the main portion includes a plurality of receiving members that are laterally spaced apart and arranged in a linear array.

7. The trussing apparatus of claim 1, wherein a radius of curvature of a center section of the at least one receiving member varies from a radius of curvature of at least one end section of the at least one receiving member.

8. The trussing apparatus of claim 1, wherein a radius of curvature of a center section of the at least one receiving member is less than a radius of curvature of at least one end section of the at least one receiving member.

9. The trussing apparatus of claim 1, wherein at least one receiving member is configured to receive various sizes, shapes, and cuts of meat therein.

10. The trussing apparatus of claim 1, further comprising at least one end portion coupled the main portion.

11. The trussing apparatus of claim 10, wherein the at least one end portion is configured to raise the main portion off of a supporting surface.

12. The trussing apparatus of claim 10, wherein at least one of the main portion and the at least one end portion is formed from a stainless steel material.

13. The trussing apparatus of claim 10, further comprising a handle coupled to at least one of the main portion and the at least one end portion.

14. The trussing apparatus of claim 10, wherein the at least one end portion includes a frame and at least one cross-member coupled to the frame.

15. The trussing apparatus of claim 14, wherein the frame includes a first pair of opposing side members and a second pair of opposing side members.

16. The trussing apparatus of claim 15, wherein the first pair of opposing side members are laterally offset from the second pair of opposing side members.

17. A trussing apparatus, comprising:
a main portion configured to cooperate with at least one restraining element capable of securing at least one piece of meat; and
at least one end portion coupled to the main portion, wherein the at least one end portion is configured to facilitate a positioning of the trussing apparatus.
